(19) United States
(12) Patent Application Publication
(10) Pub. No.: US 2015/0058277 A1
(43) Pub. Date: Feb. 26, 2015

(54) NETWORK INFERENCE USING GRAPH PRIORS

(71) Applicant: THOMSON LICENSING, Issy de Moulineaux (FR)

(72) Inventors: Efstratis IOANNIDIS, San Francisco, CA (US); Han Liu, Davis, CA (US); Smriti Bhagat, San Francisco, CA (US); Chen-Nee Chuah, Davis, CA (US)

(21) Appl. No.: 14/459,886

(22) Filed: Aug. 14, 2014

Related U.S. Application Data
(60) Provisional application No. 61/869,394, filed on Aug. 23, 2013.
(60) Provisional application No. 61/985,122, filed on Apr. 28, 2014.

(51) Int. Cl. G06N 7/00; G06F 17/30

(52) U.S. Cl. CPC G06N 7/005; G06F 17/30958
USPC 706/52

(57) ABSTRACT

A method for observing social network propagation commences by establishing a graph of the social network, the graph having nodes and edges. Thereafter a graph prior is determined that reflects the graph's structure. A set of edge probabilities between nodes in the graph is iteratively optimized a using the graph prior, wherein each of said edge probabilities represents a probability of a first node influencing a second node.

### CROSS-REFERENCE TO RELATED APPLICATIONS

This application claims priority under 35 U.S.C. §119(e) to U.S. Provisional Patent Application Ser. No. 61/869,394, filed Aug. 23, 2013, the teachings of which are incorporated herein.

### BACKGROUND

1. Technical Field

The present principles relate to graph analysis and, more particularly, to observing epidemic propagations and inferring the underlying network over which the propagation takes place.

2. Related Art

The social network graph inference problem amounts to observing epidemic propagations (e.g., the spread of a disease or product adoption over a population or a tweet, a hashtag, or a universal resource locator (URL) over a social network) and inferring from them the underlying network structure over which the propagation took place. One exemplary application is to determine the most central or the most influential users of a social network. In turn, this information can be used to construct an advertising campaign, e.g., by specifying which individuals represent the most-likely adopters or endorsers of a product to ensure the maximum possible spread of product adoption across the social network.

There are several recent approaches of inferring the underlying unobserved social network from cascade traces. Under a version of the so-called independent cascade model, the maximum likelihood estimation of such races reduces to a convex optimization problem. These approaches observe that the above optimization problems are separable, and thus amenable to large scale parallelization. If all users appear as seeds sufficiently often, the so-called “first-edge” inference algorithm performs quite well in determining the graph. While these approaches provide a framework for addressing epidemic propagation observation, such approaches present a massively parallelizable convex optimization problem.

### SUMMARY

According to an embodiment of the present principles, a method for observing social network cascades (propagations) commences by establishing a graph of the social network, the graph having nodes and edges. Thereafter a graph prior is determined that reflects the graph's structure. A set of edge probabilities between nodes in the graph is iteratively optimized a using the graph prior, wherein each of said edge probabilities represents a probability of a first node influencing a second node.

According to an another embodiment in accordance with the present principles, a system for social network cascades includes a processor configured to establish a graph of the social network, the graph having nodes and edges. The processor then determines a graph prior that reflects the graph's structure. Thereafter, the processor iteratively optimizes a set of edge probabilities between nodes in the graph using the graph prior, wherein each of said edge probabilities represents a probability of a first node influencing a second node.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a diagram of an influence graph in accordance with the present principles;

FIG. 2 is a block/flow diagram of a method for determining influence probabilities for the edges of a graph in accordance with the present principles;

FIG. 3 is a block/flow diagram of a method for determining a graph structure in accordance with the present principles; and

FIG. 4 is a block diagram of a graph inference system in accordance with the present principles.

### DETAILED DESCRIPTION

The present principles provide for the observation of epidemic propagation and the inference of an underlying network over which such propagation takes place using social network graphs and graph priors that reduce the parallelizable convex optimization problem. The present principles include a wider class of graph priors than just a generic graph prior and go beyond convex optimization, providing a solution to inference problems under a majorize-minimize (MM) approach.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be performed through the use of dedicated hardware as well as hardware capable of executing software in association with appropriate software. When performed by a processor, the functions may be performed by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

The present embodiments accomplish network inference by augmenting existing inference techniques through the use of a graph and graph priors that capture inherent information known about the network. For example, a well-studied phenomenon among social networks is that their degree distribution follows a power law degree. The present principles incorporate this information in the inference process, leading to at least two technical advantages. First, inferences are improved, providing a more accurate estimation of an underlying graph, as the prior distribution (e.g., power law) is known. Second, the present principles enable a method for testing whether the underlying graph over which the cascade is, e.g., power-law or Erdos-Renyi/Poisson.

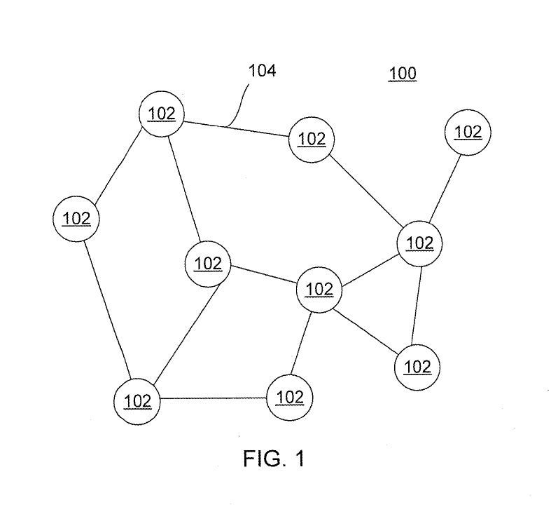

Referring now to FIG. 1, an exemplary graph 100 is shown. The graph 100 comprises nodes 102, each representing, e.g., a user in a social network. The nodes 102 are connected to one another by edges 104. Each edge 104 represents a potential for influence, where the edge 104 has an associated weight that corresponds to a probability that one user 102 on the edge 104 will be “infected” or “influenced” if the other user 102 on the edge 104 is similarly infected or influenced. Each edge 104 may be unidirectional or bidirectional. A bidirectional edge may be represented as two unidirectional edges, each of which may have a different weight.

Given a set of n users V, a series of cascades over V may be observed. Each cascade amounts to the propagation of, e.g., a piece of information, the adoption of a product, etc. A cascade c is represented through n time-stamps

T^{c}={tᵢ^{c}}_{i∈V},

each indicating the time at which the user i got “infected” (i.e., adopted the product, obtained the piece of information, etc.). If a user i did not get infected by the cascade c, then the timestamp for that user is considered to be tᵢ^{c}=+∞. Thus a given cascade c shows a collection of infection times for users 102 and shows the spread of the information through the graph 100.

The set of all cascades c is C and the set of all timestamps for a given cascade is referred to as the trace of that cascade, providing all available information about which users were infected and when. It should be noted that the trace T only captures when a user was infected, but not which user caused the infection.

The observed cascades, as described above, are the effect of the propagation of the “infection” over a graph. In particular, there exists a directed graph G whose nodes are the users V having edges E that connect users V along potential infection paths. For example, if an edge exists between users i and j, this implies that the user l can infect the user j. Whenever i gets infected, it may contact the user j (e.g., by posting the new information on their blog or by mentioning that they use the product) and trigger j's infection. Not all edges have equal strength, as some users may be more influential than others in that, when they are infected, they are very likely to infect their neighbors in G. The present embodiments infer the underlying graph G as well as the strength of influence of each edge in the graph by observing the trace of cascades T.

As in any inference task, the estimation of the underlying graph from observed cascades relies on certain assumptions as to how the cascades take place over G. According to the present model, whenever a user becomes infected, it also attempts to infect all of its neighbors in G. For each edge in E, the probability that i succeeds in infecting j is bᵢⱼ∈(0, 1]. Equivalently, one may interpret the node i as attempting to infect all nodes in G, where the probability of success is zero if the edge between i and j is not in E. If the infection succeeds, it manifests after a time t from the time i was infected, where t is sampled from a known probability distribution (e.g., Poisson, exponential, etc.). The density function of the probability distribution is denoted herein as w(t), where t≧0.

This formulation gives a principled means for attempting to discover the graph G as well as the influence strength of each individual through a Maximum Likelihood Estimation (MLE). The graph G can be obtained from the support of the edge probabilities, where E includes all edges where bᵢⱼ>0. As such, the estimation of the graph and the strength of each pairwise influence amounts to estimating the set of edge probabilities B.

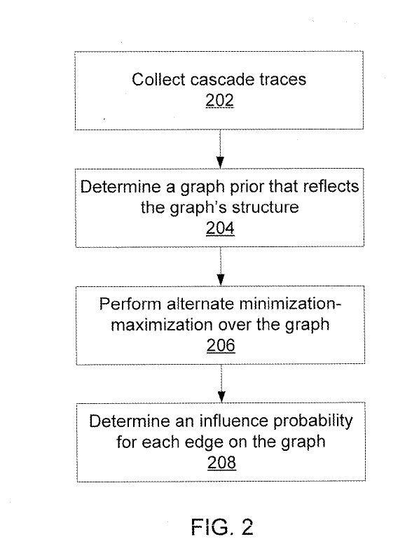

Referring now to FIG. 2, a method for estimating the edge probabilities of the graph 100 of FIG. 1 is shown. The method commences at Block 202 which collects traces c for the spread of information among the users 102 on the graph 100. This may be done by observing the network's behavior over time and following the spread of information from user to user. The Block 206 performs an alternate minimization-maximization over the graph 100 to estimate the structure of the graph. This is an iterative minimization process that locates a local minimum characterizing the set of influence probabilities, B. From the output of this process, a block 208 determines the weight of each edge as bᵢⱼ, establishing not only the likelihood that a given node 102 will influence its neighbor, but also establishing which nodes are connected to which other nodes.

The likelihood L that a trace T occurs given influence probabilities B is given by:

$$\begin{matrix}L ( T , B ) = {\prod }_{c ∈ C}^{ } ( {\prod }_{i : {t}_{i}^{c} = ∞}^{ } Pr ( i not infected ) \cdot {\prod }_{i : {t}_{i}^{c} < ∞}^{ } Pr ( i infected at {t}_{i}^{c} ) ) \\ = {\prod }_{i ∈ V}^{ } [ {\prod }_{c ∈ C : {t}_{i}^{c} = ∞}^{ } ( {\prod }_{j : {t}_{j}^{c} < ∞}^{ } 1 - {b}_{ij} ) \cdot \\ {\prod }_{c ∈ C : {t}_{i}^{c} < ∞}^{ } ( 1 - {\prod }_{j : {t}_{j}^{c} \leq {t}_{i}^{c}}^{ } 1 - w ( {t}_{i}^{c} - {t}_{j}^{c} ) {b}_{ij} ) ] .\end{matrix}$$

Using this notation, the MLE of B from the trace T amounts to minimizing −log(L) subject to bᵢⱼ∈[0,1] for all i and j in V, where

$$- log ( L ) = - {\sum }_{i ∈ V}^{ } [ {\sum }_{c ∈ C : {t}_{i}^{c} = ∞}^{ } {\sum }_{j : {t}_{j}^{c} < ∞}^{ } log ( 1 - {b}_{ij} ) + {\sum }_{c ∈ C : {t}_{i}^{c} < ∞}^{ } log ( 1 - {\prod }_{j : {t}_{j}^{c} \leq {t}_{i}^{c}}^{ } 1 - w ( {t}_{i}^{c} - {t}_{j}^{c} ) {b}_{ij} ) ]$$

The MLE is separable and thus is amenable to parallelization. In other words, the problem of estimating the set of probabilities B can be reduced by using the MLE to solve n simpler optimization problems, one for each user in V, each of which can be solved by a different processor. There is a way of transforming these n problems to convex optimization problems, which can then be solved by standard techniques.

The present principles incorporate prior information regarding the graph G in estimating the probabilities B. It can be known, for example, that the graph follows a particular distribution, such as a power law. Block 204 determines this feature of the graph 100 of FIG. 1. If P(B) is a Bayesian prior distribution over the model parameters B, then the MLE becomes the following a posteriori estimation:

Minimize: −log(L)−log(P(B))

subject to: bᵢⱼ∈[0,1], ∀ i,j∈V,

where the additional term in the objective effectively penalizes models B with small prior probability.

In contrast to the prior-free case, the result of the optimization may not be convex or reducible to a problem that is convex. However, incorporating priors can yield a significant improvement in the quality of the computed solution. This is because, for many real-world networks, some prior structure is already known. Incorporating this structure can yield a significant improvement in the estimation of both the influence probabilities B as well as their support in the graph G.

Discussed herein are two general classes of priors that approximate many interesting, well-known cases of graph structures, including the power-law distribution. Although the resulting MLE problems are not necessarily convex, they are nonetheless amenable to solution through an Alternate-Majorization-Minimization (AMM) approach in block 206.

The first distribution to consider is one in which the prior on B depends on the l₁ norm of the incoming edges to a node. In particular, let b.ᵢ={bᵢⱼ}_{j≠i}∈[0,1]ⁿ⁻¹ be the vector of influence probabilities of users influencing i. The priors are of the form:

$$P ( B ) = {\prod }_{i ∈ V}^{ } f ( {‖ {b}_{\cdot i} ‖}_{1} )$$

where f is a density that depends only on the l₁ norm of the underlying vector b.ᵢ. Note that, by its product form, this prior implies that the prior exhibits independence with respect to the influence exerted on each user. Throughout this analysis, it is assumed that the density of f is strictly positive, differentiable, log-convex, and non-increasing over the positive real numbers. The priors that satisfy this assumption include may interesting practical cases, such as the Laplace/exponential prior, f(x)=Ce^{-λx}, and the power-law prior, f(x)=C(x+∈)^{-a}, for some a>0. In both cases, the constants C are such that the integral of the densities is 1 over the feasible domain of b₋₁, namely [0,1]ⁿ⁻¹.

For such priors, the MLE can be performed through the AMM method. To begin with, the product form of the prior implies that the problem is separable and can be solved by solving n optimization problems. It suffices to solve the following for each i in V:

Minimize: Lᵢ(T; b.ᵢ)−log(f(∥b.ᵢ∥₁))

subject to: bᵢⱼ∈[0,1],∀j∈V\i,

where Lᵢ is given by:

$${ℒ}_{i} ( T ; {b}_{\cdot i} ) = - {\sum }_{c ∈ C : {t}_{i}^{c} = ∞}^{ } {\sum }_{j :: {t}_{j}^{c} < ∞}^{ } log ( 1 - {b}_{ij} ) - {\sum }_{c ∈ C : {t}_{i}^{c} < ∞}^{ } 1 - {\prod }_{j : {t}_{j}^{c} \leq {t}_{i}^{c}}^{ } ( 1 - w ( {t}_{i}^{c} - {t}_{j}^{c} ) {b}_{ij} )$$

The expression is evaluated using the following variable transformation:

dᵢⱼ=log(1−bᵢⱼ) and γ_{c}=1−Π_{j:t}_{ⱼ}_{^{c}}_{≦t}_{ᵢ}_{^{c}}(1−w(tᵢ^{c}−tⱼ^{c}), such that the optimization problem may be rewritten as:

Minimize: −Σ_{c∈C:t}_{ₜ}_{^{c}}_{=∞Σ}_{j::t}_{ⱼ}_{^{c}}_{<∞}γ_{c}−log(f(Σ_{j∈V\{i}}1−e^{d}^{ᵢⱼ}))

subject to: dᵢⱼ≦0, ∀j∈V\{i},

γ_{c}≦0, ∀ c∈C, and

log(e^{γc}+Π_{j:t}_{ⱼ}_{^{c}}_{≦t}_{ᵢ}_{^{c}}(1−w(tᵢ^{c}−tⱼ^{c})(1−e^{d}^{ᵢⱼ})))≦0.

Using the following definitions:

d={dᵢⱼ}_{j∈V\{i}},

γ={γ_{c}}_{c∈C},

G(d, γ)=−Σ_{c∈C:t}_{ᵢ}_{^{c}}_{=∞Σ}_{j::t}_{ⱼ}_{^{c}}_{<∞}dᵢⱼ−Σ_{c∈C:t}_{ᵢ}_{^{c}}_{<∞}γ_{C}, and

F(d)=−log(f(Σ_{j∈V\{i}}1−e^{d}^{ᵢⱼ})),

then the minimization problem can be written as:

Minimize: G(d,γ)+F(d)

subject to: (d,γ)∈D,

where D is the feasible domain of the minimization.

The minimization problem can be solved using AMM as follows:

(d^{k},γ^{k})=argmin_{(d,γ)∈D}(G(d,γ)+∇F(d^{k-1})^{T}(d−d^{k-1})).

This sets out an iterative approach to finding the probabilities, as k is incremented with each iteration. Under the assumption set forth above, AMM decreases the objective of the minimization problem set out above with each step. Furthermore, the minimization in AMM is a convex optimization problem. As the parameters d and γ depend on the probabilities bᵢⱼ, block 208 can then extract the probabilities for each edge on the graph 100.

The AMM approach offers a method for solving a problem that involves an objective that can be written as the sum of two functions, one concave and one convex. The AMM approach generally works iteratively, by constructing a sequence of values x₁,x₂, . . . ,xₖ,xₖ₊₁, . . . , where each value xₖ₊₁ is a compound as a function of xₖ. In particular, at each step, the solution xₖ₊₁ is constructed by solving a minimization problem, in which the concave objective is replaced by a linear approximation. In the above description, the convex function is G and the concave function is F. The process of determining xₖ₊₁ from xₖ is given above. The AMM approach terminates when it reaches a fixed point, such that xₖ₊₁=xₖ. The present methods reduce a problem to one where AMM may apply and performs this computation efficiently.

In another example. the graph priors may be of the form

$$( B ) = {\prod }_{i ∈ V}^{ } f ( {\sum }_{j ∈ V \backslash \{ i \}}^{ } \frac{1}{1 - {b}_{ij}} ) ,$$

where f is again a density satisfying the assumption stated above. As with priors depending on the l₁ norm, increasing bᵢⱼ decreases the probability P(B). As such, the MLE approach again penalizes solutions with high values of B. Contrary to priors depending on the l₁ norm, however, the case where an influence probability approaches 1 is heavily penalized, as this density becomes, in effect, zero. This is a natural scaling, given that B ranges between zero and one.

In this case, the optimization problem is expressed as:

Minimize:

$${ℒ}_{i} ( T ; {b}_{\cdot i} ) - log ( f ( {\sum }_{j ∈ V \backslash \{ i \}}^{ } \frac{1}{1 - {b}_{ij}} ) )$$

subject to: bᵢⱼ∈[0,1],∀j∈V\i,

where Lᵢ is defined above. Using the variable transformation

$${y}_{j} = \frac{1}{1 - {b}_{ij}}$$

and by letting y={yⱼ}_{j∈V\{i}}, the optimization problem may be rewritten as:

Minimize: Lᵢ(T; b.ᵢ)+F(y)

subject to: y∈ [symbol] ₊ⁿ⁻¹,

where

$$F ( y ) = - log ( f ( {\sum }_{j ∈ V \backslash \{ i \}}^{ } \frac{1}{1 - {b}_{ij}} ) ) .$$

This can again be solved using the AMM approach as follows:

(y^{k})= [symbol] (Lᵢ(T; y)+∇F(y^{k-1})^{T}(y−y^{k-1})).

Using AMM approach as described above, one can determine, given a trace of cascades T, whether the cascades were generated over a power-law graph or an exponential graph. More generally, given two priors f₁ and f₂, satisfying the above assumption, the present embodiments determine whether the trace was generated by the first class or the second class.

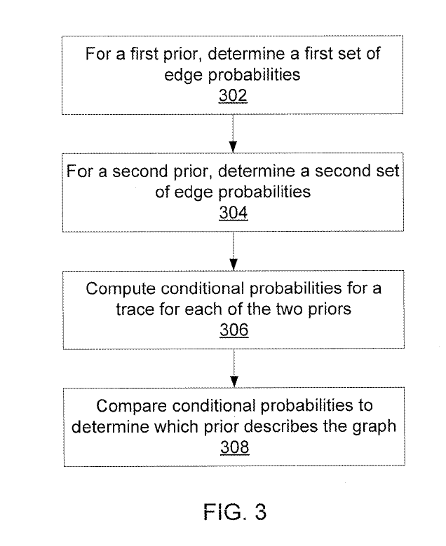

Referring now to FIG. 3, a method for determining the structure of a graph is shown. Blocks 302 and 304 compute the most likely parameters B₁ and B₂ using the two priors respectively. In the examples described above, the first prior f₁ may be based on the l₁ norm, while the second prior f₂ may be of the form P(B)=

$${\prod }_{i ∈ V}^{ } f ( {\sum }_{j ∈ V \backslash \{ i \}}^{ } \frac{1}{1 - {b}_{ij}} ) .$$

Block 306 then computes the conditional probabilities P(T|B₁) and P(T|B₂) of the observed traces using either of the two models. Block 308 then makes a prediction of the structure of the graph based on which of the calculated conditional probabilities is greater. If P(T|B₁)>P(T|B₂), then the graph is determined to have the structure of the first prior f₁, whereas if P(T|B₁)<P(T|B2), then the graph is determined to have the structure of the second prior f₂. It should be noted that the conditional probabilities are given by P_{f}(T|B)=L(T;B), the likelihood function described above.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

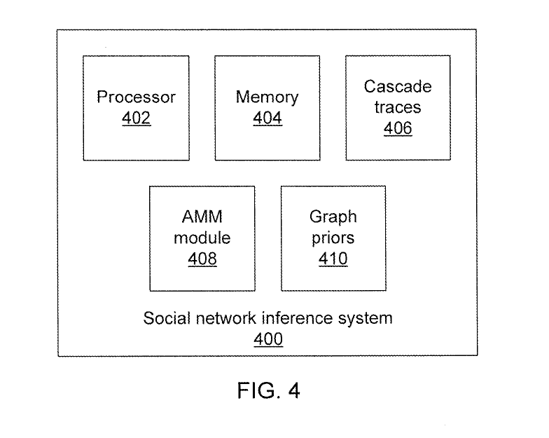

Referring now to FIG. 4, a social network inference system 400 is shown. The system 400 includes a processor 402 and a memory 404. The memory 404 stores a collection of cascade traces 406 and potential graph priors 410, where the cascade traces 406 include timestamps that represent the spread of information and influence across a graph 100. An AMM module 408 uses processor 402 to analyze the cascade traces 406 with the benefit of a selected graph prior 410 to determine the structure and strength of influence relationships between users 102 on the graph. Alternatively, the AMM module 408 may be employed as described above to determine a best fit graph prior for a given graph using the cascade traces.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for determining social network inferences, comprising:
establishing a graph of the social network, the graph having nodes connected by edges;
determining a graph prior that reflects a structure of the graph; and
iteratively optimizing a set of edge probabilities between nodes in the graph using the graph prior, wherein each of said edge probabilities represents a probability of a first node influencing a second node.

2. The method of claim 1, wherein iteratively optimizing the set of edge probabilities between nodes comprises performing an alternate minimization-maximization.

3. The method of claim 2, wherein performing an alternate minimization-maximization comprises minimizing an objective function that is a sum of a convex function and a concave function.

4. The method of claim 1, wherein the graph prior depends on the l₁ norm.

5. The method of claim 4, wherein the prior is of the form
$${\prod }_{i ∈ V}^{ } f ( {‖ {b}_{\cdot i} ‖}_{1} )$$
where V is a set of nodes in the graph, f( )is a density function that depends on the l₁ norm of an underlying vector b.ᵢ that represents the influence probabilities of users that influence the user i.

6. The method of claim 5, wherein the density function is strictly positive, differentiable, log-convex, and non-increasing over the real numbers.

7. The method of claim 1, wherein the prior is of the form
$${\prod }_{i ∈ V}^{ } f ( {\sum }_{j ∈ V \backslash \{ i \}}^{ } \frac{1}{1 - {b}_{ij}} )$$
where V is a set of nodes in the graph, f( )is a density function, and bᵢⱼ is the influence probability between a node i and a node j.

8. The method of claim 7, wherein the density function is strictly positive, differentiable, log-convex, and non-increasing over the real numbers.

9. A non-transitory computer readable storage medium comprising a computer readable program for finding the space spanned by user profiles, wherein the computer readable program when executed on a computer causes the computer to perform the steps of claim 1.

10. A system for social network inferences, comprising:
a processor configured to (a) establish a graph of the social network, the graph having nodes connected by edges; (b) determine a graph prior that reflects a structure of the graph; and (c) iteratively optimize a set of edge probabilities between nodes in the graph using the graph prior, and wherein each of said edge probabilities represents a probability of a first node influencing a second node.

11. The system of claim 10, wherein the optimization module is an alternate minimization-maximization module configured to perform an alternate minimization-maximization to optimize the set of edge probabilities.

12. The system of claim 11, wherein the alternate minimization-maximization module is configured to minimize an objective function that is a sum of a convex function and a concave function.

13. The system of claim 10, wherein the graph prior depends on the l₁ norm.

14. The system of claim 13, wherein the prior is of the form
$${\prod }_{i ∈ V}^{ } f ( {‖ {b}_{\cdot i} ‖}_{1} )$$
where V is a set of nodes in the graph, f( ) is a density function that depends on the l₁ norm of an underlying vector b.ᵢ that represents the influence probabilities of users that influence the user i.

15. The system of claim 14, wherein the density function is strictly positive, differentiable, log-convex, and non-increasing over the real numbers.

16. The system of claim 10, wherein the prior is of the form
$${\prod }_{i ∈ V}^{ } f ( {\sum }_{j ∈ V \backslash \{ i \}}^{ } \frac{1}{1 - {b}_{ij}} )$$
where V is a set of nodes in the graph, f( ) is a density function, and bᵢⱼ is the influence probability between a node i and a node j.

17. The system of claim 16, wherein the density function is strictly positive, differentiable, log-convex, and non-increasing over the real numbers.
